(19) United States
(12) Patent Application Publication
(10) Pub. No.: US 2025/0158525 A1
(43) Pub. Date: May 15, 2025

(54) COMMUNICATING SENSED INDUCTOR-CURRENT INFORMATION FROM A POWER STAGE TO A PHASE CONTROLLER IN A MULTI-PHASE SWITCHING CONVERTER

(71) Applicant: Shaoxing Yuanfang Semiconductor Co., Ltd., Shaoxing (CN)

(72) Inventors: Arnold J. D'Souza, Bangalore (IN); Shyam Somayajula, Bangalore (IN)

(21) Appl. No.: 18/619,226

(22) Filed: Mar. 28, 2024

(30) Foreign Application Priority Data
Nov. 14, 2023 (IN) 202341077437

(51) Int. Cl. H02M 3/158; H02M 1/00

(52) U.S. Cl. CPC H02M 3/158; H02M 1/0009

(57) ABSTRACT

A power stage of a multi-phase switching converter contains a high-side switch and a low-side switch to respectively drive an inductor in a first interval and a second interval periodically based on a control signal. The inductor is connected to a junction of the high-side switch and the low-side switch. The power stage contains a current-sense block to generate information representing a magnitude of inductor-current flowing through the inductor on an output node of the power stage. The power stage contains a switch connected between the output node and an output pin of the power stage. When the power stage is inactive, a portion of the current-sense block driving the output node is maintained in a powered-ON state, and the switch is operated to be open to disconnect the output node from the output pin. In an embodiment, the portion is an amplifier.

### PRIORITY CLAIM

The instant patent application is related to and claims priority from the co-pending provisional India patent application entitled, “Current Sense Offset in APM (Automatic Phase Management)”, Serial No.: 202341077437, Filed: 14 Nov. 2023; Attorney docket no.: AURA-348-INPR, which is incorporated in its entirety herewith to the extent not inconsistent with the description herein.

### BACKGROUND

### Technical Field

Embodiments of the present disclosure relate generally to power supply circuits, and more specifically to communicating sensed inductor-current information from a power stage to a phase controller in a multi-phase switching converter.

### Related Art

A switching converter refers to a component which generates a regulated DC (direct current) voltage from an input power source by employing one or more switches, as is well known in the relevant arts. Typically, a switching converter transforms the voltage (input supply voltage) of the input power source into a pulsed voltage by operating switch(es), the pulsed voltage then being smoothed using capacitors, inductors, and other elements to generate the regulated DC voltage. Power is supplied from the input to the output by turning ON and OFF switches (e.g., MOSFETs) to generate and regulate the desired voltage. Switching converters are used in components such as regulated power supplies, which in turn are used in devices such as computers and mobile phones, as is also well known in the relevant arts.

A switching converter often contains a pair of switches driving an inductor. Each switch is typically implemented as a transistor (e.g., MOSFET) and the switches are connected in series between input supply voltage and a reference terminal (e.g., ground). The switch coupled closer to the input voltage (source of input power to the converter) is termed as the high-side switch, while the other one is termed as a low-side switch. The switches are operated by a control circuit which switches ON the transistors in successive non-overlapping time durations to cause the switch that is currently ON to drive the inductor in the corresponding duration.

A multi-phase switching converter contains multiple ones of such pairs of switches, along with associated circuitry for each pair. Each pair is typically operated in a corresponding phase of a sequence of phases, with the pairs together operating to generate the desired regulated voltage and capable of supporting higher load currents at greater efficiencies as well as providing other advantages, as is well known in the relevant arts. Each of such pairs, along with the associated circuitry, is referred to as a power stage of the multi-phase switching converter. A phase controller operates to control the specific times that each of the power stages is operative in generating the desired output voltage.

Phase controllers often need to be communicated the magnitude of current supplied to the output by each power stage via a corresponding inductor, termed inductor-current information. Therefore, each power stage obtains (senses) the current through the inductor corresponding to that power stage, and provides the inductor-current information to the phase controller.

Several aspects of the present disclosure are directed to communicating sensed inductor-current information from a power stage to a phase controller in a multi-phase switching converter.

### BRIEF DESCRIPTION OF THE VIEWS OF DRAWINGS

Example embodiments of the present disclosure will be described with reference to the accompanying drawings briefly described below.

FIG. 1 is a block diagram of an example system in which several aspects of the present disclosure can be implemented.

FIG. 2A is a block diagram illustrating the details of a voltage regulation module (VRM) in an embodiment of the present disclosure.

FIG. 2B is a diagram illustrating example waveforms of some signals of power stages in a prior implementation.

FIG. 3A is a diagram illustrating the implementation details of a power stage in an embodiment of the present disclosure.

FIG. 3B is a diagram illustrating example waveforms of some signals of power stages implemented according to several aspects of the present disclosure.

FIG. 4 is a diagram illustrating pertinent details of a current-sense block in an embodiment of the present disclosure.

In the drawings, like reference numbers generally indicate identical, functionally similar, and/or structurally similar elements. The drawing in which an element first appears is indicated by the leftmost digit(s) in the corresponding reference number.

### DETAILED DESCRIPTION

### 1. Overview

According to an aspect of the present disclosure, a power stage of a multi-phase switching converter contains a high-side switch, a low-side switch, a current-sense block and a switch. The high-side switch and the low-side switch respectively drive an inductor in a first interval and a second interval periodically based on a control signal. The inductor is connected to a junction of the high-side switch and the low-side switch. The power stage contains a current-sense block to generate information representing a magnitude of inductor-current flowing through the inductor on an output node of the power stage. The power stage contains a switch connected between the output node and an output pin of the power stage. When the power stage is inactive, a portion of the current-sense block driving the output node is maintained in a powered-ON state, and the switch is operated to be open to disconnect the output node from the output pin.

In an embodiment, the portion of the current-sense block driving the output node is an amplifier, and the information provided on the output pin is a current. The amplifier has a non-zero output offset voltage that causes the current provided on the output node to be non-zero even when the power stage is inactive.

Several aspects of the present disclosure are described below with reference to examples for illustration. However, one skilled in the relevant art will recognize that the disclosure can be practiced without one or more of the specific details or with other methods, components, materials and so forth. In other instances, well-known structures, materials, or operations are not shown in detail to avoid obscuring the features of the disclosure. Furthermore, the features/aspects described can be practiced in various combinations, though only some of the combinations are described herein for conciseness.

### 2. Example System

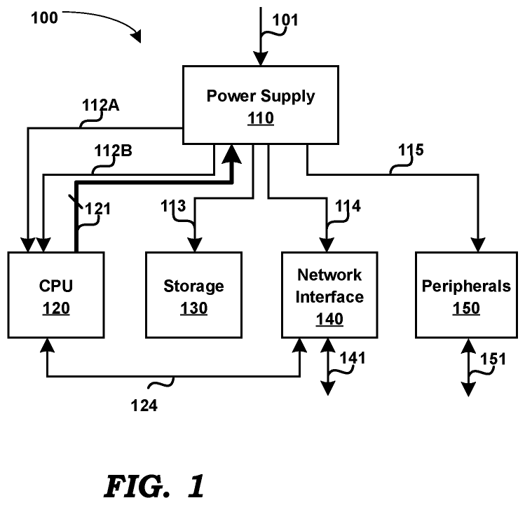

FIG. 1 is a block diagram of an example system in which several aspects of the present disclosure can be implemented. System 100 is shown containing power supply 110, central processing unit (CPU) 120, storage 130, network interface 140 and peripherals 150. In an embodiment, system 100 corresponds to a computer (desktop, laptop, etc.), although system 100 can represent other types of systems in other embodiments. It is understood that system 100 can contain more or fewer blocks than those shown in FIG. 1.

CPU 120, in general, represents a processor or a system-on-chip (SoC), and is shown as receiving a pair of supply voltages (Va and Vb) on respective paths 112A and 112B from power supply 110. As an example, Va may be a smaller voltage than Vb, and may be used to power a core portion of CPU which may include arithmetic logic unit (ALU), microprogram sequencer, registers, etc. Vb may be used to power the rest of CPU 120, such as for example, input/output (I/O) units, I/O buffers, on-chip peripherals etc. CPU 120 provides various signals (all deemed to be contained in path 121) specifying, among others, its power supply requirements to power supply 110. Examples of such signals can be those that specify the specific mode of operation (in terms of power consumption) such as PS1, PS2, PS3, etc., which refer to “Power Save States for Improved Efficiency”.

Storage 130 represents a memory that may include both volatile and non-volatile memories. For example, in a personal computer, storage can include magnetic memory (hard disk) as well as solid state memory (RAM, Flash, etc.). Storage 130 is shown receiving a supply voltage on path 113 for powering various circuits and blocks within.

Network interface 140 operates to provided two-way communication between system 100 and a computer network, or in general the Internet. Network interface 140 implements the electronic circuitry required to communicate using a specific physical layer and data link layer standard such as Ethernet or Wi-Fi™. Network interface 140 may also contain a network protocol stack to allow communication with other computers on a same local area network (LAN) and large-scale network communications through routable protocols, such as Internet Protocol (IP). Network interface 140 receives a power supply on path 114 for powering internal circuits and blocks. Network interface 140 receives from/transmits to external systems and CPU 120 respectively on path 141 and path 124.

Peripherals 150 represents one or more peripheral circuits, such as for example, speakers, microphones, user interface devices, etc. Peripherals 150 receives a power supply on path 115, and communicates with external devices on path 151.

Power supply 110 receives power from one or more sources (e.g., battery) on path 101, and operates to provide the desired power supply voltages on paths 112A, 112B, 113, 114 and 115. In an embodiment, power supply 110 is designed to contain one or more multi-phase DC-DC converters within to generate the power supply voltages. Power supply 110 responds to signals from CPU 120 received on path 121 to control the multi-phase converters to reduce/increase current output based on the specific signal (e.g., PS1, PS2 and PS3).

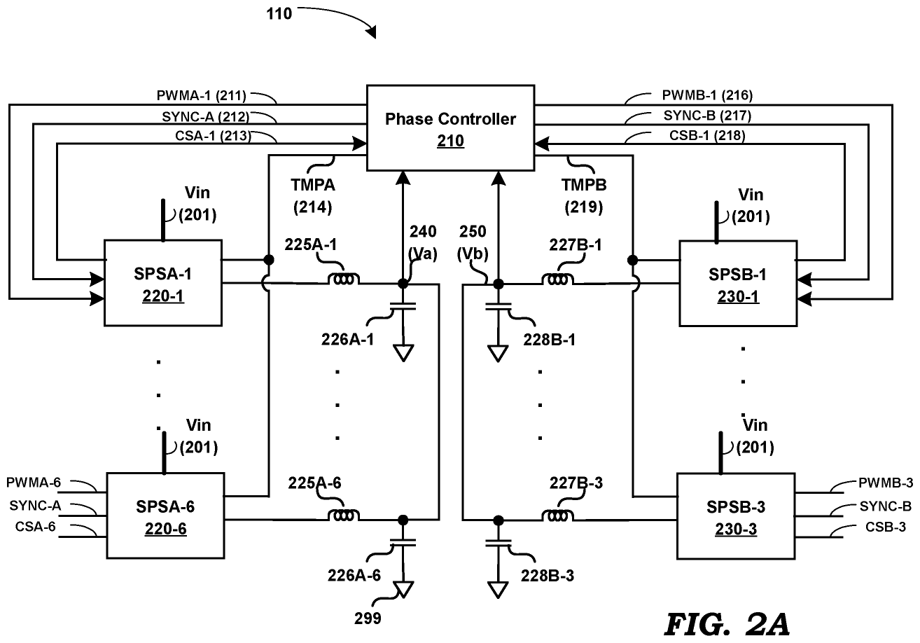

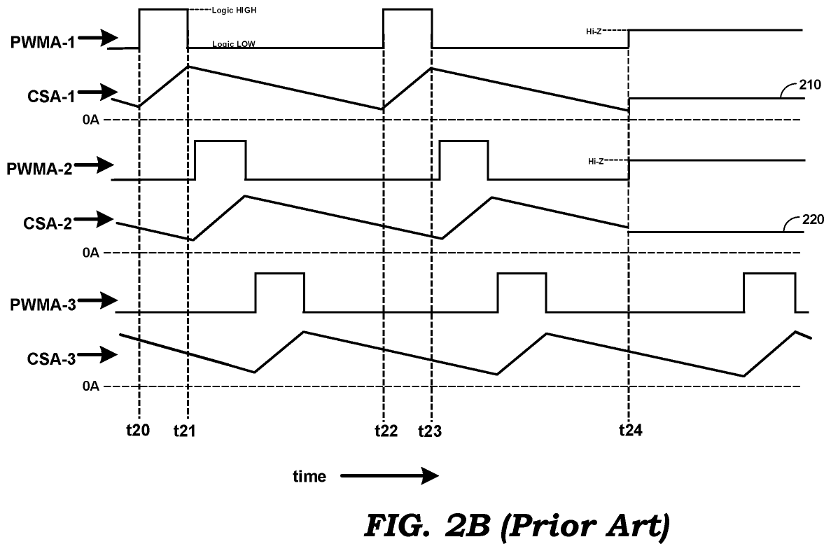

In the embodiment, power supply 110 is a voltage regulator module (VRM), sometimes also called processor power module (PPM), and contains one or more step-down switching (buck) converters to generate several smaller voltages from a higher-voltage supply source. In other embodiments however, other types of DC-DC converters such as boost, buck-boost, hysteretic converters etc., can be implemented instead of a buck converter. With a VRM, multiple devices/ICs requiring different supply voltages can be mounted on the same platform, for example, a computer motherboard of a personal computer (PC). Accordingly, the description is continued with respect to a VRM as shown in FIG. 2A.

### 3. Voltage Regulator Module (VRM)

FIG. 2A is a block diagram illustrating the details of a VRM in an embodiment of the present disclosure. Power Supply 110 (of FIG. 1) is implemented as a Voltage Regulator Module implemented in the form of a multi-phase switching converter generating two regulated voltages Va (240) and Vb (250).

VRM 110 is shown containing phase controller 210, smart power stages (SPS) SPSA-1 (220-1) through SPSA-6 (220-6), SPSB-1 (230-1) through SPSB-3 (230-3), inductors 225A-1 through 225A-6 and 227B-1 through 227B-3 and capacitors 226A-1 through 226A-6 and 228B-1 through 228B-3. Power supply Va (240) (Rail-A) is generated by a 6-phase buck converter (there are six SPSes—220-1 through 220-6), while power supply Vb (250) (Rail-B) is generated by a 3-phase buck converter (there are three SPSes-230-1 through 230-3). Nodes/Paths 240 and 250 can correspond to paths 112A and 112B of FIG. 1. In the interest of conciseness, other power supply circuits that generate supplies on paths 113, 114 and 115 are not shown in FIG. 2A.

In an embodiment of the present disclosure, each of the power stages as well as the phase controller is implemented as separate integrated circuits (ICs). However, in other embodiments, the implementations of the power stages and phase controller may be different.

Phase controller 210 in conjunction with one or more power stages of a rail operates to generate a regulated voltage as output. In the example of FIG. 2A, phase controller 210 and one or more of the power stages of Rail-A, namely SPSA-1 through SPSA-6, operates to generate regulated voltage Va (240). Similarly, phase controller 210 and one or more of the power stages of Rail-B, namely SPSB-1 through SPSB-3, operates to generate regulated voltage Vb (250). Accordingly, Va (240) and Vb (250) are shown as being provided as inputs to phase controller 210 to enable operation of one or more feedback loops within phase controller 210 to regulate voltages Va and Vb. Phase controller 210 also receives inductor-current information (regarding current flowing through each of the inductors) from each of the SPSes to enable various operations such as current-mode control of voltage regulation, current limiting, short circuit protection, and balancing the currents generated by each SPS of a same converter (or ‘rail’) so as to make the currents from each SPS of a converter to be substantially equal in magnitude. and Vb. The other signals flowing between phase controller 210 and the SPSes are described below.

The combination of (corresponding circuitry within) phase controller 210, an SPS and the corresponding inductor and capacitor forms one “phase” of a rail. Thus, for example, SPSA-1, inductor 225A-1, capacitor 226A-1, and the corresponding portion within phase controller 210 form a single buck converter, and one phase of the 6-phase buck converter. It is noted here that, while each phase is shown as having its own separate capacitor (e.g., 226A-1), in another embodiment, only a single larger capacitor (larger capacitance) may be employed at node 240 (as well as 250). In other embodiments, multiple capacitors are placed close to the load powered by the corresponding supply voltage.

Each SPS (or in general a ‘power stage’) may be implemented to contain a high-side switch, a low-side switch, gate-drive circuitry for the two switches, a temperature monitor circuit and an inductor-current sense circuit/block to provide information indicating the magnitude of inductor current to phase controller 210. The current supplied by an SPS, and therefore the corresponding inductor-current generally depends on the load current drawn from the supply voltage, although the high-side switch and low-side switch of an SPS may be viewed as ‘driving’ the inductor. Each SPS receives a source of power (which can all be the same source) as an input which is connected to the high-side switch (shown in detail in sections below). In FIG. 2A, the supply source is numbered 201, and has a voltage Vin. An example value of Vin in an embodiment of VRM 110 is about 21 volts (V).

Each SPS communicates with phase controller 210 via corresponding signals PWM, SYNC, CS and TMP. Thus, SPSA-1 is shown connected to phase controller 210 through signal/paths PWMA-1 (211), SYNC-A (212), CSA-1 (213) and TMPA (214). SPSA-6 communicates with phase controller 210 via signals PWMA-6, SYNC-A, CSA-6 and TMP (214), although in FIG. 2A, the respective connections of signals PWMA-6, SYNC-A and CSA-6 to phase controller 210 are not shown. Similarly, SPSB-1 is shown connected to phase controller 210 through signal/paths PWMB-1 (216), SYNC-B (217), CSB-1 (218) and TMPB (219). SPSB-3 communicates with phase controller 210 via signals PWMB-3, SYNC-B, CSB-3 and TMP (219), although in FIG. 2A, the respective connections of signals PWMB-3, SYNC-A and CSB-3 to phase controller 210 are not shown. The other SPSes would have similar connections with phase controller 210. Each SPS has a PWM, SYNC, CS and TMP is received/transmitted via pins on

Signal PWM is an input to an SPS from phase controller 210 and represents a pulse-width modulated (PWM) signal. A PWM signal may be generated to have a logic HIGH state, a logic LOW state or a high-impedance (Hi-Z) state. Typically, the logic HIGH and logic LOW states of the PWM signal correspond respectively to the voltages (within error/noise margins) of the positive and negative rails of the power supply of the circuit generating the PWM signal, and the Hi-Z state corresponds to the mid-rail voltage of the power supply (or a voltage-window around the mid-rail voltage), as is well known in the relevant arts. However, other conventions can be employed for the three states of the PWM signal as would be apparent to one skilled in the relevant arts. Typically, the PWM signal needs to remain within the voltage-window noted above for a predetermined minimum duration for a power stage to correctly identify a Hi-Z state.

The PWM signal controls the opening and closing of high-side switch and low-side switch of a phase/power stage via the logic HIGH and logic LOW states. Typically, the logic HIGH state is used to switch ON (i.e., close) the high-side switch and switch OFF (i.e., open) the low-side switch (the corresponding duration may be referred as the ‘first interval’), while the logic LOW state is used to switch ON the low-side switch and switch OFF the high-side switch (the corresponding duration may be referred as the ‘second interval’). Each cycle of the PWM signal has a ‘first interval’ and a ‘second interval’.

The Hi-Z state of the PWM signal indicates to the power stage that the power stage is not to operate in generating the output voltage, i.e., be ‘inactive’. Thus, when PWM is in the Hi-Z state, both the high-side and low-side switches of the stage are OFF, and the power stage can go to low-power/power-down modes. In general, phase controller 210 is designed to generate the PWM signal in a manner capable of indicating three states, with one of the three states indicating that the corresponding power stage is to be inactive. It will be apparent to one skilled in the relevant arts that such tri-state capability can be implemented in other ways. As an example, phase controller 210 can be implemented to generate PWM as a conventional binary signal with the power stages implemented to identify a Hi-Z state if the PWM signal is turned OFF, i.e., not generated at all.

The duty cycle of the PWM signal is set by phase controller 210 and is designed to generate the desired power supply voltage and/or control/change the current supplied by that phase. For example, PWMA-1 would have a duty cycle as required for the magnitude of Va and the current to be provided by SPSA-1. As is well known in the relevant arts, the PWM signals to each SPS of a same converter may be staggered, i.e., delayed with respect to each other in phase such that typically no two high-side switches of a rail (i.e., in respective SPSes) are ON at the same time. Such a technique is employed for reasons such as, for example, to ensure that the peak instantaneous current drawn from Vin is relatively low at all times.

Signal TMP is an output (e.g., a voltage) from an SPS to phase controller 210, and provides information regarding the temperature in the SPS. Phase controller 210 may process the TMP signal (or the information contained in it) to adjust the current supplied by that phase, or for shut-down of the VRM in the event of a fault. The TMP outputs of each phase of a converter are wired together, and a single input (for e.g., TMPA 214) is connected to phase controller 210. The maximum of the TMP outputs of a phase is driven on the wired connection.

Signal SYNC is an input to an SPS and may be used by phase controller 210 for the purposes of waking-up the SPS upon power-up of the power supply 110, and also to indicate the power-mode (e.g., PS2, PS3), i.e., output current requirement, of the multi-phase converter. Typically, all SPSes of the same converter share a single SYNC signal (e.g., SYNC-A 212).

Signal CS (current-sense) is an input to phase controller 210 from an SPS/phase, and contains information regarding the magnitude of the inductor-current of that phase. The information can be in the form of a current, voltage, digital values, etc., depending on the specific implementation of the power stages and phase controller 210. A CS block in an SPS implements the current-sense operation and sends signal CS to phase controller 210.

In an embodiment of the present disclosure, the current-sense block of a power stage sends the sensed inductor-current information to phase controller 210 in the form of a current that can be of either the same magnitude as the inductor-current or (more typically) be a scaled-down version (in terms of magnitude) of the inductor-current. Correspondingly, in the embodiment, phase controller 210 is designed to receive the information in the form of a current, with the scaling factor being known to phase controller 210 as well as the (corresponding) power stage when scaling is used.

Phase controller 210 may be designed to implement automatic phase management (APM). Accordingly, the specific number of power stages (or phases) operated by phase controller 210 can vary depending, for example, on the magnitude of load-current drawn from a rail (e.g., Va 240). In general, the smaller the load-current is, fewer are the number of power stages used/operated and vice-versa.

As an example, for very low load-currents drawn from rail-A (Va 240) phase controller 210 may use/operate only one power stage (termed the ‘active’ power stage) to generate Va, and maintain the other five power stages in an ‘inactive’ mode. Therefore, phase controller 210 generates the PWM signal to control switching of the high-side and low-side switches of only the one active power stage to generate Va, and maintain the PWM signals to the other five power stages in the Hi-Z state. Therefore, the high-side and low-side switches of those five inactive power stages would all be OFF (not switching). An example situation in which the load-current may be very small and phase controller 210 may maintain only a small number (e.g., one) of power stages in the active state is when VRM 110 is operating in DCM (Discontinuous Conduction Mode). As is well known in the relevant arts, DCM refers to a mode in which the inductor-current of a power stage falls to zero during a PWM logic-LOW interval and remains zero until the next logic-HIGH transition of the PWM signal.

When a power stage is unused (i.e., inactive), one or more circuits/blocks (including the current-sense block) in that power stage can be powered-down or maintained in low-power/sleep modes to reduce power consumption. However, a possible drawback with such an approach is that it may take an unacceptable delay to bring the corresponding block(s) back to a powered and operational state in case of need such as, for example, a sudden increase in load-current demand. Hence, at least some circuits/blocks of an ‘inactive’ power stage (i.e., one whose PWM input signal is in a Hi-Z state) of VRM 110 may be maintained in a fully powered-up state.

For example, a current-sense (CS) amplifier (whose output is connected to the CS pin) in the CS block of the inactive stage may be held in reset (i.e., input signals to the amplifier may be disconnected or set to pre-determined fixed level such as, for example, zero volts), but maintained in a fully-powered state (meaning that all circuit portions of the CS amplifier are powered-ON). Alternatively, all portions of the CS block may be maintained in a fully-powered state. One drawback with such a situation (and in particular, maintaining the CS-amplifier in a fully-powered state) is that the CS amplifier's DC offset-current would still be flowing into the CS pin, and therefore to the corresponding input pin of phase controller 210. The term ‘DC offset current’ of the CS amplifier refers to the magnitude of the output current (typically a constant value) generated by the CS amplifier when the input signals of the CS amplifier are held at zero volts or some other fixed voltage as noted above.

As an example, referring to FIG. 2A, if SPSA-1 is in the inactive state, some (non-zero) offset-current may still flow on the CSA-1 (213) pin/path. Such offset-current may (wrongly) add to the total sensed-current provided to phase controller 210, thereby affecting the operation of phase controller 210. As noted above, phase controller 210 utilizes the inductor-current information from the power stages for various purposes. Thus, for example, the non-zero offset-current may affect various control loops (including voltage-regulation control loop) operated by phase controller 210. The error contributed by the offset-current may be particularly pronounced when the load-current is small.

FIG. 2B is a diagram illustrating example PWM waveforms and sensed-current (CS current) waveforms of three power stages of a same power rail, for example, power stages SPSA-1, SPSA-2 and SPSA-3 of Rail-A in a prior implementation of the power stages of VRM 110. For ease of illustration, it is assumed in the example of FIG. 2B that power Rail-A contains only the three power stages SPSA-1, SPSA-2 and SPSA-3. Waveforms PWMA-1 (211 in FIG. 2A) and CSA-1 (213 in FIG. 2A) respectively represent the PWM signal provided as input to SPSA-1 and the sensed inductor-current provided by SPSA-1 to phase controller 210. Similarly, waveforms PWMA-2 and CSA-2 respectively represent the PWM signal provided as input to SPSA-2 and the sensed inductor-current provided by SPSA-2 to phase controller 210. Waveforms PWMA-2 and CSA-2 respectively represent the PWM signal provided as input to SPSA-2 and the sensed inductor-current provided by SPSA-2 to phase controller 210.

All the three phases/stages SPSA-1, SPSA-2 and SPSA-3 are assumed to be active until time instant t24. Accordingly, all of PWMA-1, PWMA-2 and PWMA-3 are shown as switching between logic HIGH and logic LOW states until t24. Specifically, signal PWMA-1 is shown as being logic HIGH in intervals t20-t21 and t22-t23, and logic LOW in intervals t21-t22 and t23-t24. PWMA-2 and PWMA-3 are also shown as switching between logic HIGH and logic LOW states until time instant t24. The three PWM signals are shown to be staggered. The respective sensed inductor-current waveforms provided by each stage are shown as increasing and decreasing respectively when the corresponding PWM signal is a logic HIGH and logic LOW.

At, or slightly prior to t24, the load-current is assumed to have substantially reduced, and therefore phase controller 210 de-activates SPSA-1 and SPSA-2, and maintains only SPSA-3 active. Accordingly, PWMA-1 and PWMA-2 are each shown as being in the high impedance (Hi-Z) state starting at t24. However, since phase controller 210 continues to maintain SPSA-3 active PWMA-3 continues to switch between logic HIGH and logic LOW even after t24 (a portion of the next PWM cycle is shown in FIG. 2B), and CSA-3 continues to represent the sensed inductor-current of SPSA-3. On the other hand, the magnitudes of CSA-1 and CSA-2 are respectively the corresponding offset-current of the respective current-sense (CS) amplifiers of SPSA-1 and SPSA-2. The respective offset-current magnitudes are denoted by the markers 210 and 220, assumed to be equal for simplicity. As noted above, such offset-currents on CS pins of inactive power stages are undesirable.

Embodiments of the present disclosure overcome the problems noted above as described next.

### 4. Power Stage (SPS)

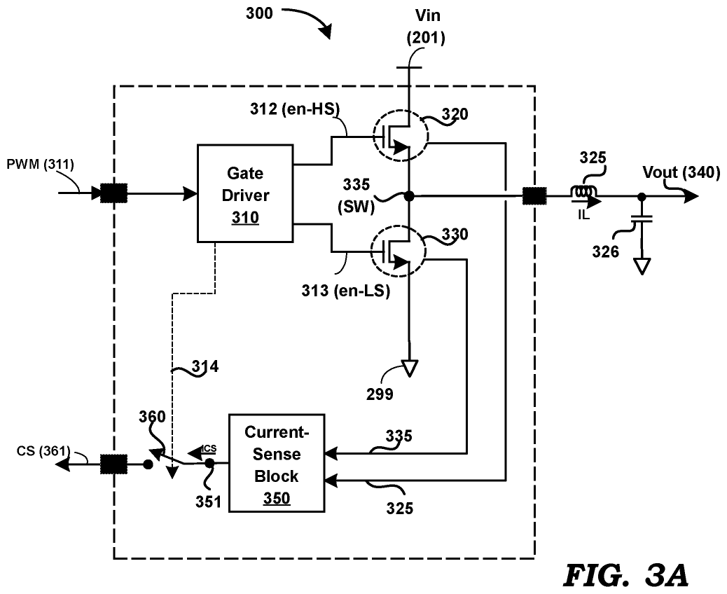

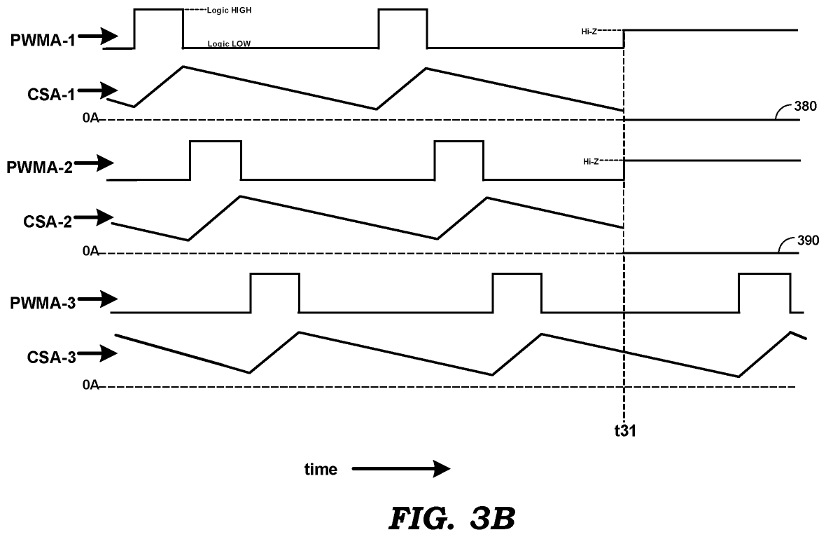

FIG. 3A is a diagram illustrating the implementation details of a power stage in an embodiment of the present disclosure. Power stage 300 is shown containing gate driver 310, high-side (HS) switch 320, low-side (LS) switch 330, current-sense block 350 and switch 360. Also shown in FIG. 3A are inductor 325 and capacitor 326 corresponding to the power stage. Current ‘IL” represents the inductor-current, and current “ICS” represents the sensed current provided as output on CS pin (361). Power stage 300, in combination with inductor 325 and capacitor 326 and a controller (such as phase controller 210 of FIG. 2A) provides a regulated voltage (Vout) as output on node 340. Although not shown in FIG. 3A in the interest of conciseness, power stage 300 may contain various other blocks/circuits such as a temperature sensor, level-converters, etc. Pins/circuits in power stage 300 that are connected to process a SYNC input signal and to provide a temperature indication output are not shown.

Power stage 300 can be implemented in place of the power stages of FIG. 2A. Nodes PWM (311) and CS (361) would correspond to the respective PWM input nodes/pins and CS node/pins of the power stages of FIG. 2A. In an embodiment of the present disclosure, power stage 300 is implemented in integrated circuit (IC) form. However, in other embodiments, power stage 300 can be implemented in different form, for example, using discrete components.

Gate driver 310 receives a PWM signal 311 (for example, from phase controller 210), and in response to the logic level of the PWM generates the appropriate voltage to turn ON and turn OFF HS switch 320 and LS switch 330 in corresponding intervals indicated by the logic levels of the PWM signal. HS switch 320 and LS switch 330 are each shown implemented as an N-channel MOSFET (Metal Oxide Semiconductor Field Effect Transistor) with gate driver 310 driving the gate terminals of the MOSFETs. Other types of implementations for the switches are also possible. In the example of FIG. 3A, when PWM 311 is a logic HIGH, gate driver 310 generates respective appropriate voltages on paths 312 (en-HS) and 313 (en-LS) to switch-ON MOSFET 320 and switch-OFF MOSFET 330. When PWM 311 is a logic LOW, gate driver 310 generates respective appropriate voltages on paths 312 and 313 to switch-OFF MOSFET 320 and switch-ON MOSFET 330. When PWM 311 is a Hi-Z state, gate driver 310 generates the respective appropriate voltages on paths 312 and 313 to switch-OFF both of MOSFET 320 and 330. Additionally, gate driver 310 is designed to generate signal 314 to open switch 360 when PWM 311 is in the Hi-Z state, and to close switch 360 otherwise.

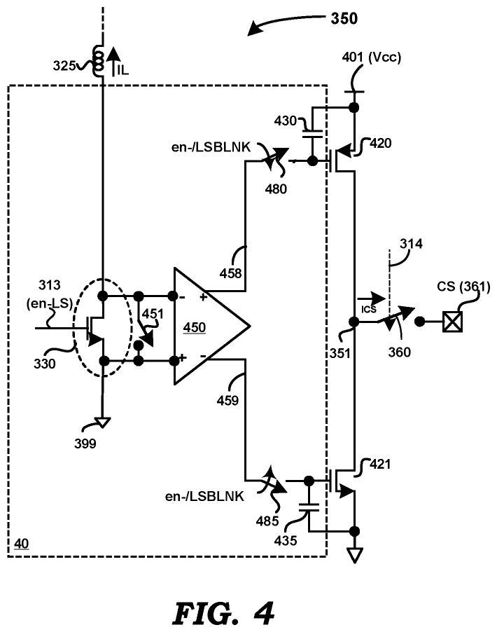

Current-sense block 350 operates to determine the magnitude (for example, instantaneous magnitude) of the inductor-current (through inductor 325), and provides information indicating the inductor-current magnitude as an output on node 351. Current-sense block 350 determines the magnitude of the inductor-current in one of several known ways. For example, in FIG. 3A current-sense block 350 is shown as receiving inputs 325 and 335 respectively from HS switch 320 and LS switch 330. In an embodiment, signals 325 and 335 represent the respective voltage-drops across the HS and LS switches when the corresponding switch is ON and current is flowing through it and inductor 325. Current-sense block 350 obtains the instantaneous magnitude (or a scaled-down version thereof) of the inductor-current based on the voltage-drops. In another embodiment described below with reference to FIG. 4, current-sense block 350 employs sensing of the voltage-drop across the LS switch 330 for directly obtaining the inductor-current magnitude (or a scaled-down version thereof) when the LS switch is ON, and ‘constructs’ (or emulates) the inductor-current magnitude when the HS switch 320 is ON. Current-sense block 350 provides information representing the inductor-current magnitude on its output node 351. In an embodiment, the information is in the form of a (replica) current (indicated as ICS) having a magnitude that is scaled-down with respect to the instantaneous inductor-current magnitude.

As noted above, when the PWM signal (311) is at Hi-Z state, power stage 300 is not operative in generating Vout, and switches 320 and 330 are OFF. However, as noted above, either all of current-sense block 350 or at least a current-sense amplifier (whose output is provided on node 351) within current-sense block 350 is maintained in a fully powered state. Therefore, a non-zero offset-current of the amplifier may be present at node 351 even when power stage 300 is non-operative.

Switch 360 is connected between node 351 and CS pin/pad (361), and is operable to be closed or open. In the example of FIG. 3A, gate driver 310 includes a circuit that detects if signal PWM (311) is in the Hi-Z state. In an embodiment, the circuit concludes that power stage 300 is to become inactive if signal PWM (311) is continuously in the Hi-Z state for a predetermined duration of time. If PWM (311) is in the Hi-Z state, the circuit opens switch 360, otherwise the circuit closes (or maintains closed) switch 360. The circuit controls the opening and closing of switch 360 via a control signal on path 314. The circuit can be implemented in a known way. Switch 360 may be implemented, for example, as a Metal Oxide Semiconductor Field Effect Transistor (MOSFET) or other types of transistors.

Due to the provision and operation of switch 360, the offset-current is prevented from being provided on CS pin 361 and therefore to phase controller. As a result, one or more of the drawbacks (e.g., as noted above) due to a non-zero offset-current being provided to the phase controller when the power stage is inactive are overcome.

FIG. 3B is a diagram illustrating example PWM waveforms and sensed-current (CS current) waveforms of power stages SPSA-1, SPSA-2 and SPSA-3 of Rail-A, with each of the power stages implemented as power stage 300 described above. In FIG. 3B, labels for the waveforms are the same as those in FIG. 2B. Most of the details of FIG. 3B are similar to those shown in FIG. 2B, and hence only the differences from the details of FIG. 2B are noted here.

At, or slightly prior to t31, the load-current is assumed to have substantially reduced, and therefore phase controller 210 de-activates SPSA-1 and SPSA-2, and maintains only SPSA-3 active. Accordingly, PWMA-1 and PWMA-2 are each shown as being in the high impedance (Hi-Z) state starting at t31. PWMA-3 continues to switch between logic HIGH and logic LOW even after t31 (a portion of the next PWM cycle is shown in FIG. 2B), and CSA-3 continues to represent the sensed inductor-current of SPSA-3. Unlike in FIG. 2B, however, each of the signals CSA-1 and CSA-2 has a magnitude equal to zero (as represented by markers 380 and 390) since the respective switches (corresponding to switch 360 of FIG. 3A) are open when power stages SPSA-1 and SPSA-2 are inactive.

The implementation details of current-sense block 350 in an embodiment of the present disclosure are provided next.

### 5. Current-Sense Block

FIG. 4 is a diagram illustrating the pertinent details of a current-sense block in an embodiment of the present disclosure. In the interest of conciseness, only the portion for sensing of inductor-current in the LS-interval (i.e., “second interval”/when LS switch is ON) is shown. The sensing of inductor-current by amplifier 450 (described below) in the HS-interval (i.e., ‘first interval’/when HS switch is ON) can be implemented in a known way. In an embodiment of the present disclosure, current-sense block 350 (and more specifically amplifier 450) is implemented to measure the inductor-current during both the first and the second intervals, and to generate the sensed-current information based thereon.

However, in alternative embodiments, current-sense block 350 can be implemented to employ measurement/sensing of the inductor-current whenever LS switch 330 is ON (‘second interval’ noted above) and emulation (or estimation rather than measurement) of the inductor-current whenever HS switch 320 is ON (‘first interval’ noted above). Such ‘emulation’ is typically employed when the duration of the PWM ON states is very short. All the switch-control signals of FIG. 4 can be generated by suitable circuits (not shown) in a known way.

Current-sense block 350 is shown containing circuit 40 and transistors 420 and 421, with the transistors together being referred to as an ‘output block’ herein. Transistors 420 and 421 are shown connected in series between a supply voltage 410 (Vcc) and ground terminal. Output node 351 of current-sense block 350 is the junction of the series-connected transistors 420 and 421. Also shown in FIG. 4 are switch 360, signal 314 and pin CS (361) of FIG. 3A.

Circuit 40 of current-sense block 350 is shown containing amplifier 450, switches 451, 480 and 485, and capacitors 430 and 435. Amplifier 450 is shown as a fully-differential amplifier (i.e., differential-input and differential-output). For clarity, LS switch 330 is also shown as part of circuit 40, although it would typically not be part of current-sense block 350. The voltage (indicated by input 335 of FIG. 3A) across LS switch 330 is applied across the inverting and non-inverting terminals of differential amplifier 450. Inductor 325 is also shown in FIG. 4.

Transistor 420 is indicated to be a P-channel metal oxide semiconductor field effect transistors (PMOS), and transistor 421 an N-channel metal oxide semiconductor field effect transistors (NMOS). Supply voltage Vcc (401) may be provided by phase controller 210, or be generated in VRM 110 in a known way.

Amplifier 450 receives the voltage across LS switch 330 in the ‘second intervals’ (i.e., when LS switch is closed), and provides an amplified output voltage as an output across terminals 458 and 459, and therefore ‘drives’ the sensed-current Ics, whenever amplifier 450 is operational. In the example of FIG. 4, amplifier 450 does not drive the output node in the blanking intervals. Amplifier 450 is shown as a fully differential amplifier merely as an example. Other amplifier types and topologies can also be used instead. In an embodiment, amplifier 450 is a fully differential amplifier with a gain determined by a feedback network (not shown, but for example using two pairs of resistors as is well known in the art) that would be used to operate amplifier 450 in closed-loop mode.

LS switch 330 is switched ON (and is therefore conductive) by signal ‘en-LS’ (313 of FIG. 3A) in (and for the duration of) the ‘second interval’ of each PWM cycle only. Thus, the current (IL) through inductor 325 is sensed by circuit 40 by measuring/obtaining the voltage-drop across the LS switch 330 in the second intervals of each PWM cycle. However, other techniques for obtaining a measure of the magnitude of inductor-current in the second intervals can also be used.

The operations of the circuits of FIG. 4 are now described for the ‘second interval’ when power stage 300 is active.

### Second Interval:

LS switch 330 is switched ON by control input en-LS (313) at the start of the second interval. The second interval itself commences with a ‘blanking interval’ to allow transients in the output of amplifier 450 to settle, and in which the output of amplifier 450 is prevented from propagating to output node 351. Control signal en-/LSBLNK causes switches 480 and 485 to be closed from the end of the blanking interval to the end of the corresponding ‘second interval’, and open for every ‘first interval’ and the blanking interval. Control signals en-/LSBLNK and en-LSBLNK are binary signals which are logical inverses of each other, and generated by a circuit (not shown) in current-sense block 350. Switch 450 is open when power stage 300 is active and closed otherwise.

Therefore, in the second interval, voltage 458 and 459 respectively cause transistors 420 and 421 to source and sink respective currents based on the specific magnitudes of voltages 458 and 459 and therefore the input voltage (voltage-drop across LS switch 330) to amplifier 450. Thus, output block effectively operates as a voltage-to-current converter. As a result, a difference current (denoted by Ics) between the current sourced by transistor 420 and the current sunk by transistor 421 flows out of node 351. Since switch 360 is closed when power stage 300 is active, the sensed-current (Ics) flows through pin/pad CS 361, and would thus be available to phase controller 210.

Additionally, capacitors 430 and 435 would charge/discharge depending on voltages on path 458 and 459 respectively, and at the end of the second interval would each have a voltage across them representative of (or corresponding to) the magnitude of the sensed-current Ics at the end of the second interval. In other words, capacitors 430 and 435 ‘hold’ the ‘information’ (in these voltages across capacitors 430 and 435) representative of sensed-current at the end of the second interval. In some embodiments in which inductor-current in the HS interval is emulated rather than sensed, such ‘valley hold’ capability of circuit 40 may be used advantageously to estimate/emulate the inductor-current in the first interval.

Amplifier 450 may be used to measure the voltage across the HS switch 320 in the first intervals and generate sensed-current Ics correspondingly in any of several known ways. As an example, the differential inputs to amplifier 450 can be connected across the high-side switch 320 (instead of low-side switch 330) in a known way in the first intervals, and Ics may be generated to represent the inductor-current in the first intervals by operation similar to that noted above. In such an implementation, switches 480 and 485 would be closed during the first intervals also, and capacitors 430 and 435 would not be implemented.

Sensed-current Ics generated as noted above is provided to phase controller 210 via switch 360 and CS pin/pad (361) when power stage 300 is active.

However, when power stage 300 is set to the inactive mode, amplifier 450 is held in a “reset” state, but is maintained fully powered-ON. One or more of the other portions of current-sense block 350 may also be maintained powered-ON. In the reset state of amplifier 450, switch 451 is closed, and the differential input voltage to amplifier 450 is zero. However, voltage across output nodes 480 and 485 may not be zero since a DC offset voltage may be present across nodes 480 and 485, thereby causing sensed-current Ics to be non-zero, at least when amplifier 450 is driving the output node 351. To prevent such non-zero current from being applied to CS pin (361), switch 360 is maintained open in the inactive mode.

As noted above, current-sense block 350 can be implemented differently than as shown in FIG. 4. Even in such alternative embodiment(s), a switch (such as 360) is used to disconnect the output of the corresponding amplifier(s) driving the output node 351 to prevent non-zero offset voltage/current at the output of the amplifier(s) from being present on the CS pin when the stage is inactive.

Although in the example above, switch 360 is noted as being implemented to prevent output offset voltage of amplifier 450 from causing a non-zero sensed-current Ics flowing into the CS pin of power stage 300 when power stage 300 is inactive, in general, switch 360 can be used to similarly prevent a non-zero sensed-current flowing into the CS pin (when the power stage is inactive) due to other reasons/causes as well, based for example, on the specific design of the current-sense block of the power stage.

### 6. Conclusion

References throughout this specification to “one embodiment”, “an embodiment”, or similar language means that a particular feature, structure, or characteristic described in connection with the embodiment is included in at least one embodiment of the present disclosure. Thus, appearances of the phrases “in one embodiment”, “in an embodiment” and similar language throughout this specification may, but do not necessarily, all refer to the same embodiment.

While in the illustrations of FIGS. 1, 2A, 3A and 4, although terminals/nodes are shown with direct connections to (i.e., “connected to”) various other terminals, it should be appreciated that additional components (as suited for the specific environment) may also be present in the path, and accordingly the connections may be viewed as being “electrically coupled” to the same connected terminals.

It should be appreciated that the specific type of transistors (such as NMOS, PMOS, etc.) noted above are merely by way of illustration. However, alternative embodiments using different configurations and transistors will be apparent to one skilled in the relevant arts by reading the disclosure provided herein. For example, the NMOS transistors may be replaced with PMOS (P-type MOS) transistors, while also interchanging the connections to power and ground terminals.

Accordingly, in the instant application, the power and ground terminals are referred to as constant reference potentials, the source (emitter) and drain (collector) terminals of transistors (though which a current path is provided when turned on and an open path is provided when turned off) are termed as current terminals, and the gate (base) terminal is termed as a control terminal.

While various embodiments of the present disclosure have been described above, it should be understood that they have been presented by way of example only, and not limitation. Thus, the breadth and scope of the present disclosure should not be limited by any of the above-described embodiments, but should be defined only in accordance with the following claims and their equivalents.

What is claimed is:

1. A power stage of a multi-phase switching converter comprising:
a high-side switch and a low-side switch to respectively drive an inductor in a first interval and a second interval periodically based on a control signal, wherein said inductor is coupled to a junction of said high-side switch and said low-side switch;
a current-sense block to generate on an output node of said power stage, information representing a magnitude of inductor-current flowing through said inductor; and
a switch coupled between said output node and an output pin of said power stage,
wherein, when said power stage is inactive:
a portion of said current-sense block driving said output node is maintained in a powered-ON state; and
said switch is operated to be open to disconnect said output node from said output pin.

2. The power stage of claim 1, wherein said portion of said current-sense block is an amplifier.

3. The power stage of claim 2, wherein said information is a current, wherein said amplifier has a non-zero output offset voltage that causes said current to be non-zero even when said power stage is inactive.

4. The power stage of claim 3, wherein said switch is closed when said power stage is active,
wherein said high-side switch and said low-side switch respectively drive said inductor in said first interval and said second interval only when said power stage is active.

5. The power stage of claim 4, wherein said control signal indicates whether said power stage is to be active or inactive.

6. The power stage of claim 5, wherein a high-impedance (Hi-Z) state of said control signal indicates that said power stage is to be inactive.

7. The power stage of claim 4, further comprising a gate driver to receive said control signal, said gate driver to generate based on a logic level of said control signal corresponding signals to operate said high-side switch and said low-side switch to be correspondingly open or closed,
wherein if a state of said control signal is said high-impedance (Hi-Z) state, said gate driver generates an output signal with a value to cause said switch to be open.

8. The power stage of claim 7, wherein said current-sense block comprises:
a fully differential amplifier coupled to receive, on differential input terminals, a voltage across said low-side switch;
a first capacitor, a second capacitor, a first transistor, a second transistor; and
a first switch, a second switch and a third switch,
wherein a first current terminal of said first transistor is coupled to a first constant reference potential, and a second current terminal of said first transistor is coupled to said output node,
wherein a first current terminal of said second transistor is coupled to a second constant reference potential, and a second current terminal of said second transistor is coupled to said output node,
wherein said first capacitor is coupled between a control terminal of said first transistor and said first constant reference potential,
wherein said second capacitor is coupled between a control terminal of said second transistor and said second constant reference potential,
wherein said first switch is coupled between a first one of a pair of differential outputs of said fully differential amplifier and said control terminal of said first transistor,
wherein said second switch is coupled between a second one of said pair of differential outputs and said control terminal of said second transistor,
wherein said third switch is coupled between said differential input terminals, wherein said third switch is operable to be closed when said power stage is inactive, and
wherein each of said first switch and said second switch is operable to be closed in said first interval and said second interval, except during a blanking interval between said first interval and said second interval.

9. A multi-phase switching converter comprising:
a plurality of power stages together generating a regulated supply voltage on a power rail; and
a phase controller to control the operation of each of said plurality of power stages to cause generation of said regulated supply voltage,
wherein a first power stage of said plurality of power stages comprises:
a high-side switch and a low-side switch to respectively drive an inductor in a first interval and a second interval periodically based on a control signal, wherein said inductor is coupled to a junction of said high-side switch and said low-side switch;
a current-sense block to generate on an output node of said power stage, information representing a magnitude of inductor-current flowing through said inductor; and
a switch coupled between said output node and an output pin of said power stage,
wherein, when said power stage is inactive:
a portion of said current-sense block driving said output node is maintained in a powered-ON state; and
said switch is operated to be open to disconnect said output node from said output pin.

10. The multi-phase switching converter of claim 9, wherein said portion of said current-sense block is an amplifier.

11. The multi-phase switching converter of claim 10, wherein said information is a current, wherein said amplifier has a non-zero output offset voltage that causes said current to be non-zero even when said power stage is inactive.

12. The multi-phase switching converter of claim 11, wherein said switch is closed when said power stage is active,
wherein said high-side switch and said low-side switch respectively drive said inductor in said first interval and said second interval only when said power stage is active.

13. The multi-phase switching converter of claim 12, wherein said control signal indicates whether said power stage is to be active or inactive.

14. The multi-phase switching converter of claim 13, wherein a high-impedance (Hi-Z) state of said control signal indicates that said power stage is to be inactive.

15. The multi-phase switching converter of claim 12, further comprising a gate driver to receive said control signal, said gate driver to generate based on a logic level of said control signal corresponding signals to operate said high-side switch and said low-side switch to be correspondingly open or closed,
wherein if a state of said control signal is said high-impedance (Hi-Z) state, said gate driver generates an output signal with a value to cause said switch to be open.

16. The multi-phase switching converter of claim 15, wherein said current-sense block comprises:
a fully differential amplifier coupled to receive, on differential input terminals, a voltage across said low-side switch;
a first capacitor, a second capacitor, a first transistor, a second transistor; and
a first switch, a second switch and a third switch,
wherein a first current terminal of said first transistor is coupled to a first constant reference potential, and a second current terminal of said first transistor is coupled to said output node,
wherein a first current terminal of said second transistor is coupled to a second constant reference potential, and a second current terminal of said second transistor is coupled to said output node,
wherein said first capacitor is coupled between a control terminal of said first transistor and said first constant reference potential,
wherein said second capacitor is coupled between a control terminal of said second transistor and said second constant reference potential,
wherein said first switch is coupled between a first one of a pair of differential outputs of said fully differential amplifier and said control terminal of said first transistor,
wherein said second switch is coupled between a second one of said pair of differential outputs and said control terminal of said second transistor,
wherein said third switch is coupled between said differential input terminals, wherein said third switch is operable to be closed when said power stage is inactive, and
wherein each of said first switch and said second switch is operable to be closed in said first interval and said second interval, except during a blanking interval between said first interval and said second interval.

17. A power stage of a multi-phase switching converter comprising:
a high-side switch and a low-side switch to respectively drive an inductor in a first interval and a second interval periodically based on a control signal, wherein said inductor is coupled to a junction of said high-side switch and said low-side switch; and
a current-sense block to generate on an output node of said power stage, a current representing a magnitude of inductor-current flowing through said inductor,
wherein no current flows from said output node to a phase controller of said multi-phase switching converter when said power stage is inactive.

18. The power stage of claim 17, wherein a portion of said current-sense block driving said output node is maintained in a powered-ON state when said power stage is inactive,
said power stage further comprising a switch coupled between said output node and an output pin of said power stage, wherein said output pin is coupled to said phase controller,
wherein said switch is operated to be open to disconnect said output node from said output pin when said power stage is inactive to prevent current-flow from said output node to said phase controller.
